(19) United States
(12) Patent Application Publication
(10) Pub. No.: US 2011/0148757 A1
(43) Pub. Date: Jun. 23, 2011

(54) OPTICAL INPUT PEN DEVICE WITH A TRIGGER-STYLE SWITCH

(75) Inventors: Randy Lathrop, Wilsonville, OR (US); Chris Haverty, Portland, OR (US)

(73) Assignee: SEIKO EPSON CORPORATION, Shinjuku-ku (JP)

(21) Appl. No.: 12/842,898

(22) Filed: Jul. 23, 2010

Related U.S. Application Data
(60) Provisional application No. 61/228,502, filed on Jul. 24, 2009.

(51) Int. Cl. G06F 3/033; G09G 5/00

(52) U.S. Cl. 345/157; 345/156

(57) ABSTRACT

An optical pen device for an image display system is provided. The optical pen device includes a trigger-style switch disposed to increase user control when using a switch on the optical pen. The switch may be actuated in a direction parallel to an optical input axis of the optical pen device.

### CROSS-REFERENCES TO RELATED APPLICATIONS

This application claims the benefit of U.S. Provisional Application No. 61/228,502, filed Jul. 24, 2009, the entirety of which is incorporated by reference herein.

### BACKGROUND

The present application relates to an optical input pen, and more specifically to an optical input pen that provides a high level of user control in an image display system.

Image display devices may be used in a variety of environments. For example, image display devices, including, but not limited to, projectors, televisions, monitors, etc., may be adapted to display images, including text, graphics, video images, still images, presentations, etc. Such image display devices may be found in educational environments, business facilities, conference rooms, meeting facilities, and the like. The following is a non-exhaustive list of exemplary image display devices or systems: cathode ray tubes (CRTs), projectors, flat panel liquid crystal display (LCDs) systems, LED systems, plasma systems, front projection systems, rear projection systems, LCD monitors, etc. Large format display devices may include but are not limited to televisions, front-projection systems, and rear-projection systems. In some cases, an image display device may project an image for display on a viewing surface, such that the image may be viewed by one or more audience members.

Image display devices may be used in a variety of environments such as educational settings (e.g., classrooms), business facilities, conference rooms, and the like. In the case of image display devices such as projectors, large format viewing may be permitted, for example, by the image display device projecting an image onto a viewing surface that is viewable by one or more audience members. A presenter giving a presentation with such an image display device needs to be able to annotate text and/or images displayed on the viewing surface while giving the presentation. Accordingly, an input device may be configured to interact with the image display device so as to allow such real-time annotations. For example, an optical pen may be used to virtually “write” on the viewing surface, and the image display device may in response display “writing” on the image. As such, the image display device and the viewing surface may collectively serve as an electronic whiteboard, wherein the optical pen serves as an electronic whiteboard pen.

Such optical input pen devices generally include at least one switch which allows a user to communicate with an external device (e.g., a projector) wirelessly and to provide inputs, for example, via actuation of the switch. However, use of the switch may result in a change of angle and/or position such that it is difficult to control the input from the optical pen. The switch is generally located on the body of the pen such that the force required to actuate the switch device is perpendicular to the optical axis of the pen; thus the action of applying force to the switch causes the user to move the pen device. Such movement may become amplified as the user moves away from the screen, resulting in changes in coordinates (e.g., mouse cursor coordinates) which are greater than intended by the user. As such, it may be difficult for a user to click on an object in a windows Windows® environment running on a computer, for example. Conventionally, effort has been applied to solve this problem in software through filtering, which provides greater complexity to a display system as a whole, and also is not effective for all users.

### BRIEF SUMMARY OF THE INVENTION

As described in more detail below, in one example, optical input pens may provide whiteboard functionality using a digital light processing (DLP) projection system or other image display system or device. The image display system may embed patterns in the projected image that may be read by an optical pen as light levels and then transmitted wirelessly to the image display system by the pen device. Through a series of patterns, the image display system may calculate where the optical pen is pointing in the projected image and transmit this to a computer as coordinates (e.g., mouse cursor coordinates). An optical input pen may include one or more switches located on the body of the pen which actuate in a direction parallel to the direction the optical pen is pointing in the projected image.

By positioning the switch in a location on the bottom of the pen with actuation parallel to the optical axis of the pen, the user may comfortably press the switch without substantial change to the angle of the pen and therefore to the location that the pen is pointing. A further advantage of such a trigger-style switch is that it may be more comfortable for the user of the optical pen device.

One embodiment of the invention provides an optical pen device including a pen housing that is functionally operable and elongated along an optical axis. An optical sensor may be located within the housing. The optical sensor may be arranged to receive a light signal transmitted along the optical axis of the housing. A transmitter may be located within the housing. The transmitter may be configured to wirelessly transmit optical signal data derived from the light signal to an external device. An activation switch may be located on the housing and configured to trigger an activation signal from the transmitter to the external device while the optical data signal is being transmitted. The activation switch may be externally triggered by a force along an actuation axis. The actuation axis may be substantially parallel to the optical axis.

In one aspect of the optical pen device, the optical sensor may include a photodetector.

In another aspect of the optical pen device, a lens may be arranged to focus the light signal onto the photodetector.

In another aspect of the optical pen device, the transmitter can include a radio frequency transmitter.

In another aspect of the optical pen device, the transmitter may be mounted to a printed circuit board within the housing.

In another aspect of the optical pen device, the switch may include a membrane switch, a carbon pill, or a capacitive switch.

In another aspect of the optical pen device, the housing may be shaped to be held in the hand of a user such that a forefinger of the user actuates the switch while a proximal portion of the housing is positioned against an adjacent palm of the user.

In another aspect of the optical pen device, the actuation axis may be positioned at a minimal distance from the optical axis.

In another aspect of the optical pen device, the actuation axis may be co-linear with the optical axis.

In another aspect of the optical pen device, the activation switch may be accessible within an opening passing through the housing.

In another aspect of the optical pen device, the activation switch may include a sliding member that actuates along a cylindrical path about the optical axis.

Another embodiment of the invention provides a display system including an image display device. The image display device may include an image generation device for projecting an image. A processor of the image display device may be configured to receive optical signal data from an input device and calculate location data for indicating where the input device is pointing on the image. A computing system may be configured to receive the location data from the image display device and send image data to the image display device, the image data being based on the location data. The display system may include an optical pen device, which includes a pen housing that may be functionally operable and elongated along an optical axis. An optical sensor may be within the housing. The optical sensor may be arranged to receive a light signal transmitted along the optical axis of the housing. The light signal may be received from the image which is projected by the image generation device. A transmitter may be located within the housing. The transmitter may be configured to wirelessly transmit optical signal data derived from the light signal to the image display device. An activation switch may be located on the housing and configured to trigger an activation signal from the transmitter to the image display device while the optical data signal is being transmitted. The activation switch may be externally triggered by a force along an actuation axis. The actuation axis may be substantially parallel to the optical axis.

In one aspect of the display system, the image display device may be a front-projection device, a rear-projection device, an LCD system, a laser system, or a large format display device.

In another aspect of the display system, the location data may include mouse coordinates.

In one aspect of the display system, the switch may include a membrane switch, a carbon pill, or a capacitive switch.

In one aspect of the display system, the housing may be shaped to be held in the hand of a user such that an index finger of the user actuates the switch while a proximal portion of the housing is positioned against an adjacent palm of the user.

In one aspect of the display system, the actuation axis may be positioned at a minimal distance from the optical axis.

In one aspect of the display system, the actuation axis may be co-linear with the optical axis.

In one aspect of the display system, the activation switch may be accessible within an opening passing through the housing.

In one aspect of the display system, the activation switch may include a sliding member that actuates along a cylindrical path about the optical axis.

### BRIEF DESCRIPTION OF THE DRAWINGS

FIG. 1A shows a schematic depiction of an optical pen device.

FIG. 1B shows a schematic depiction of how a small change in the angle of the optical pen device of FIG. 1A is amplified when distance to a screen is increased.

FIG. 2A shows a schematic depiction of a communication scheme between an optical pen device and an image display device, according to an embodiment of the invention.

FIG. 2B shows a schematic depiction of an image display system, according to an embodiment of the invention.

FIG. 3A shows a schematic depiction of an optical pen device, according to an embodiment of the invention.

FIG. 3B shows the optical pen device of FIG. 3A in use, according to an embodiment of the invention.

FIGS. 3C and 3D show schematic depictions of optical pen devices, according to respective embodiments of the invention.

### DETAILED DESCRIPTION OF THE INVENTION

As disclosed herein, an optical input pen device may include at least one switch which is disposed on the optical pen device such that the direction of force applied to the switch is parallel to the optical axis. Because the force applied to the switch is parallel to the direction the pen points (the optical axis of the pen), the action of applying force to the switch causes the optical pen device to move at a reduced angle or small angle relative to the optical axis.

Controlling such an optical pen device in a manner consistent with writing, drawing and other such precise manipulation may be challenging especially as functionalities are added to the pen. The trigger switch described herein reduces the errors which may occur with controlling an optical pen. It can be appreciated that the herein-described examples are non-limiting and are provided to aid in illustrating various embodiments of a tip for an optical pen.

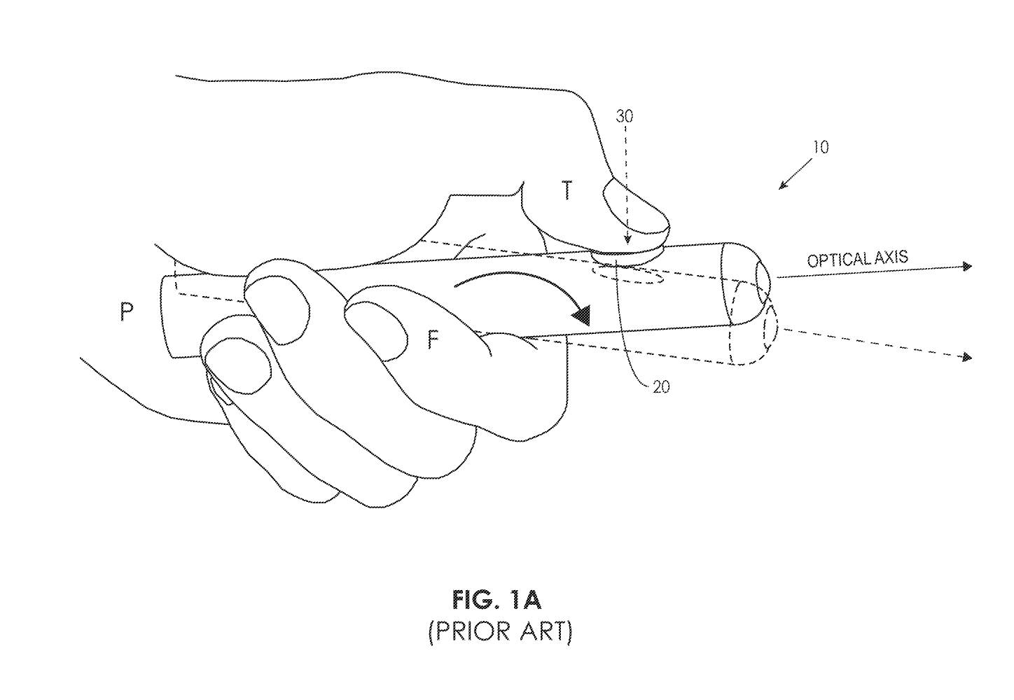

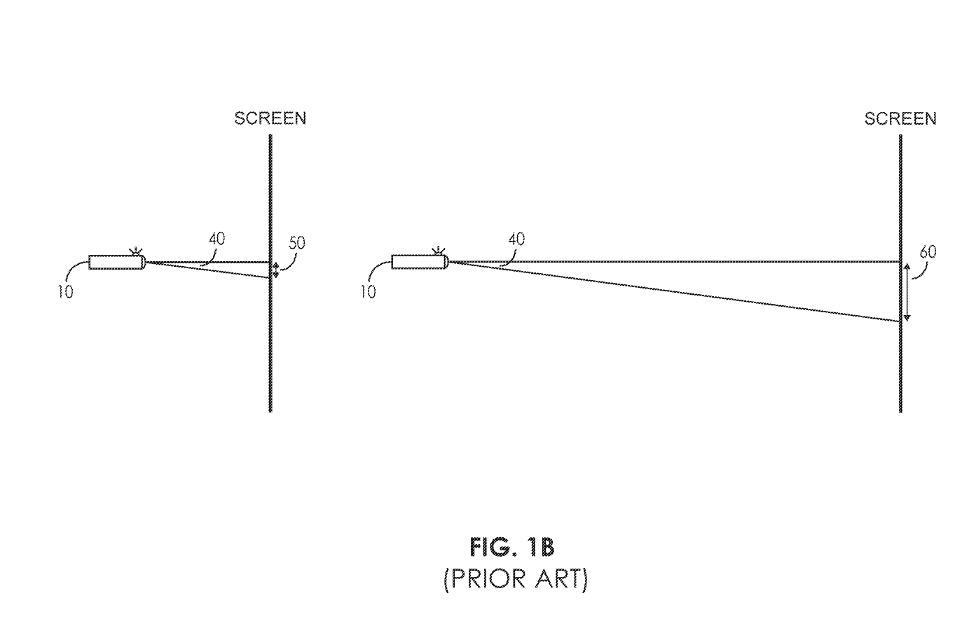

FIG. 1A shows a typical prior art optical pen device 10. Conventionally, at least one switch is located on the optical pen device 10 such that the direction of the force 30 required to actuate a switch is perpendicular to an optical axis. The optical axis regards the direction in which a light signal is received from a projected image on a screen. As shown, the user's forefinger F will act as a fulcrum when the force 30 is inputted to the pen 10 by the thumb T. The pen 10 will thus rotate around the index finger F to some degree from the applied leverage, and move in a downward direction.

In use, the optical pen device 10 is pointed with respect to the optical axis at the projected image to indicate a location on the image. This location can be processed to display a cursor where the optical pen device 10 is directly pointing (i.e., where the optical axis intersects with the projected image). In such a scenario, the force 30 applied to the switch is perpendicular to the direction that the pen points (the optical axis of the pen). This creates a change in the angle of the pen that moves the cursor, making it difficult for a user to click on an object in a Windows® environment, for example. Thus, when the user attempts to click on the object, the cursor will move in a relatively downwards direction and the attempted click may not occur on the intended object. This can be frustrating to the user, and accordingly requires filtering software to compensate for. As users tend to input with varying levels of force, such filtering software cannot necessarily compensate for this movement in a reliable or consistent manner for all users.

FIG. 1B shows a schematic depiction of how a small change 30 in the angle of the optical pen device 10 is amplified when the distance from the pen to a screen is increased. The optical pen device 10 is shown positioned at a first distance from a screen. If a small change 40 in the angle of the optical pen device 10 relative to the screen occurs, e.g., when a switch is actuated with a force in a direction perpendicular to the optical axis, a first change 40 is communicated to the screen. If the optical pen device 10 is positioned at a second distance greater than the first distance from the screen, the small change 40 in the angle of an optical pen device 10 results in a second change 60 greater than the first change 40. Accordingly, even a relatively small and unintended angle change is undesirable.

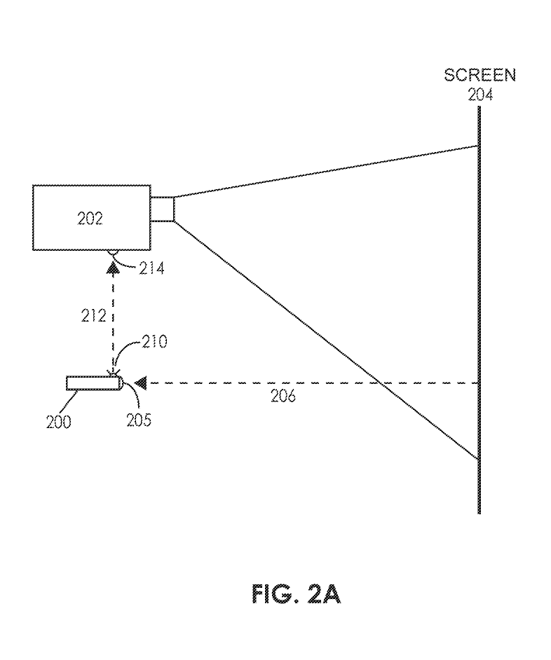

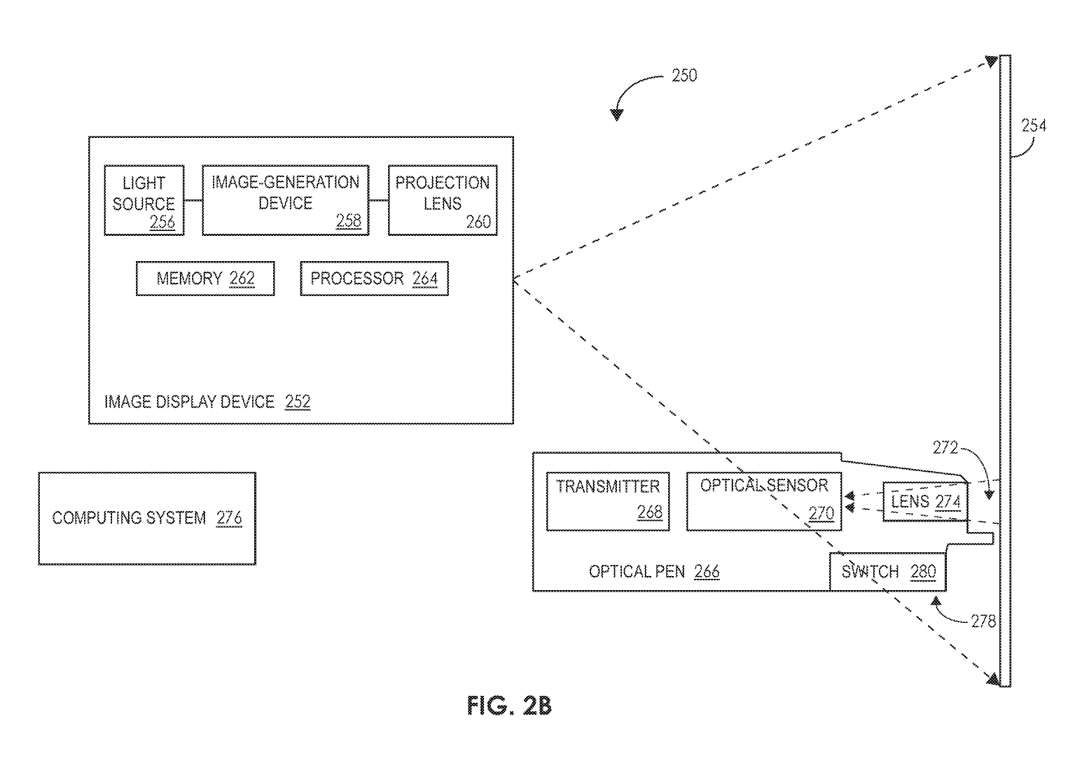

Turning now to the figures, FIG. 2A shows a schematic depiction of a communication scheme between an optical pen device 200 and an image display device, such as a projector 202. The projector 202 may project an image onto a screen 204 and embed patterns of light levels in the projected image which may then be received by optical pen device 200 along the direction of optical axis 206 via a lens 208. The optical pen device 200 may transmit input optical signal data received from the image to projector 202 via a transmitter 210 (e.g., a radio frequency transmitter). The signal may be transmitted along a path 212 to a receiver 214 located on projector 202.

FIG. 2B shows an embodiment of an image display system 250. The image display system 250 may include an image display device 252 configured to project an image onto a viewing surface 254. For example, the image display system 250 may be a system configured for displaying an image in a large display format for group viewing. As described and illustrated herein, the image display device 252 may be a projection device, such as a front-projection device. However, it should be appreciated that the image display device 252 may be another type of display device, including, but not limited to, a rear-projection system. In other embodiments, the image display device 252 may be an LCD system, laser system, large format display device, etc. Accordingly, the image display device 252 may utilize any suitable technology for displaying the image on the viewing surface 254, such as digital light processing.

The image display device 252 may include a light source 256, configured to direct light toward an image-generation device 258. In some embodiments, the light source 256 may include a lamp positioned within a reflector that may be configured to direct most of the emitted light along an optical path of the system. The light source 256 may include any suitable type of lamp or light source, including, but not limited to, metal halide lamps and ultra-high-pressure (UHP) arc lamps, lasers, light emitting diodes (LED), organic light emitting diodes, etc. The light source 256 may also include one or more filters, such as an infrared (IR) or ultraviolet (UV) filter, to filter out unwanted parts of the emission spectra of the lamp.

As described above, the image-generation device 258 may be configured to receive light from light source 256, and in response generate an image. The image-generation device 258 may include an optical engine, image-producing element, filters, color wheels, lenses, mirrors, integrators, condensers, and other suitable optical elements. Such elements may be configured to generate an image. For example, the image-generation device 258 may include an image-producing element, such as, but not limited to, a digital micromirror (DMD), an LCD panel, or any other suitable image source. In some embodiments, the image-producing element may be configured to project light toward one or more lenses, mirrors or other optics, which, in turn, may be configured to project light toward the viewing surface. In some embodiments, a projection lens 260 may be configured to display the image on the viewing surface 154. Non-limiting examples of the viewing surface may include a screen, a wall, etc.

The image display device 252 may further include memory 262. Memory 262 may be operatively coupled to a processor 264, such that processor 264 may execute instructions stored on memory 262. In such a case, the image display device 252 may be configured to receive data from an input device, such as optical pen device 266, as described in more detail as follows.

Optical pen 266 may include a transmitter 268 for sending data to image display device 252. As a non-limiting example, transmitter 268 may be a radio frequency transmitter. Optical pen 266 may further include an optical sensor 270 for receiving light of the image displayed on the viewing surface 254 that has reflected back from the viewing surface 154, i.e., reflected image light.

As a non-limiting example, optical sensor 270 is configured to receive an optical input 272, which is reflected image light. Reflected image light may first enter through a lens 274 prior to being received by optical sensor 270, which may be a photodetector. It can be appreciated that optical pen 266 is a non-limiting example of an optical pen, and other such optical pens may be used as input devices within image display system 250.

In some cases, the image display device 252 may be further configured to embed patterns within the image. As such, the optical pen device 266 may be further configured, upon receiving reflected image light via optical sensor 270, to read these patterns as a light level to derive optical signal data. The optical pen 266 may then be further configured to transmit the optical signal data to the image display device 252, for example, as a wireless transmission or a wired transmission. The image display device 252 may be further configured, through a series of patterns, to calculate a location of the optical pen device 266 within the image projected onto viewing surface 254. Upon calculating the location (i.e., where, in the projected image, the optical pen is pointing), the image display device 252 may be further configured to transmit location data to a computing system 276.

As a non-limiting example, the location data may be continuously or intermittently transmitted by the transmitter 268 to the image display device 252 and ultimately to the computing system 276 as mouse coordinates. In response, the computing system 276 may interact with image display device 252 to display image data at the location. Image data may be in the form of a generated visual indicator, such as cross-hairs or a mouse cursor. Additionally, the optical pen device 266 can send an activation signal to the image display device via a user actuation of switch 280. The activation signal is ultimately transmitted to the computing system 276 to indicate a user command, such as a mouse click, writing command, or drawing command. The activation signal may be sent along with the location data by the 268 transmitter. Thus, optical pen device 266 may be used for writing, drawing, etc. so as to utilize the image display system 250 as an electronic whiteboard. It should be understood that the image display system 250 is a non-limiting example of an image display system, and other embodiments of the image display system may include an optical pen device 266 configured to interact with an image display device 252 in another suitable manner.

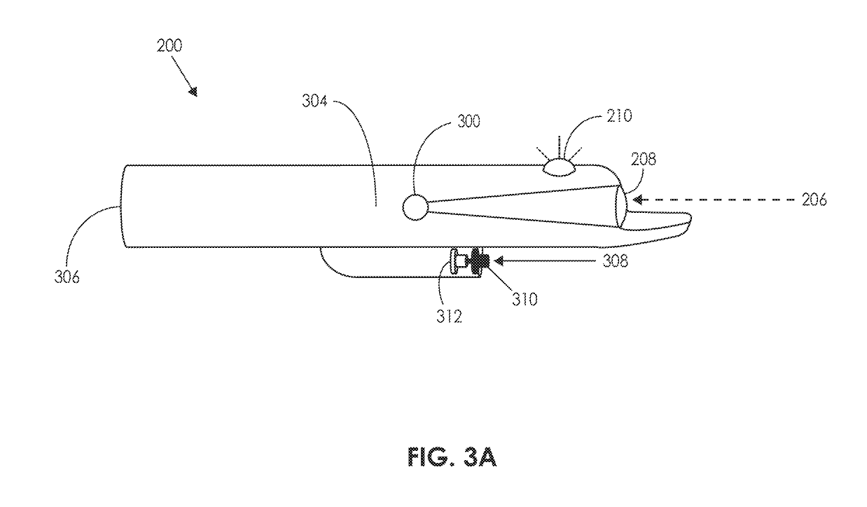

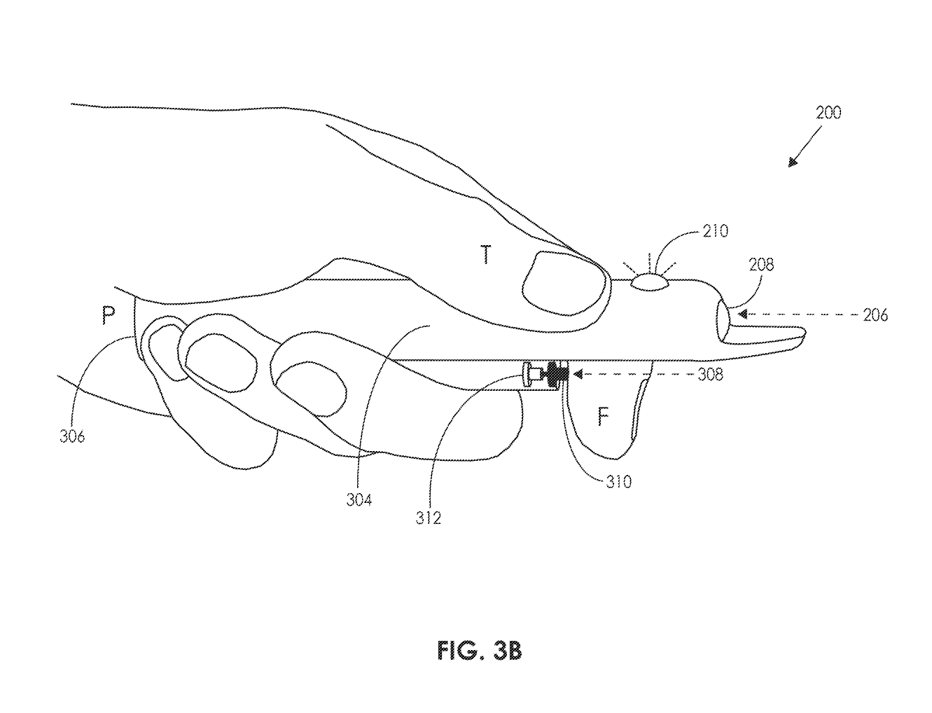

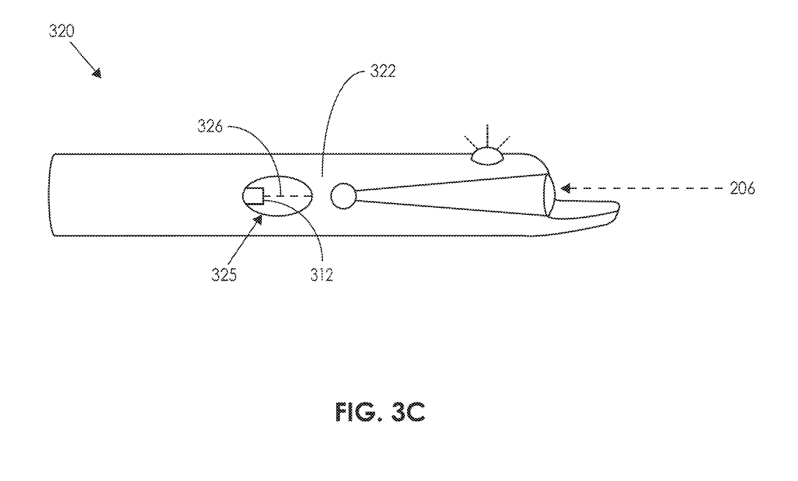

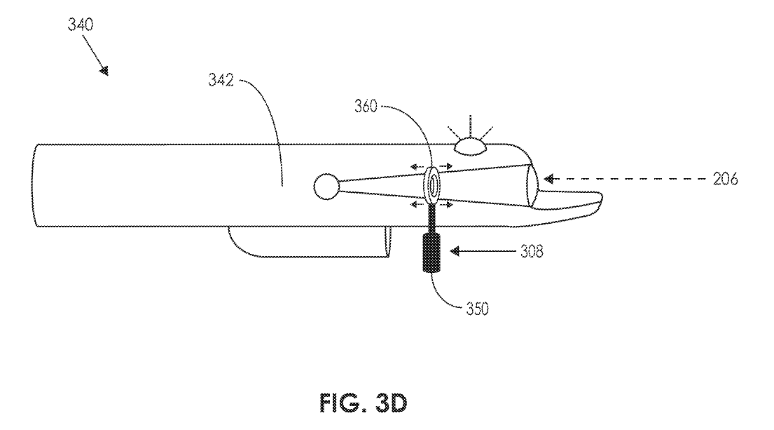

Turning now to FIG. 3A, a schematic depiction of an exemplary optical pen device 200 is illustrated. In this example, the optical axis 206 of the optical pen device 200 indicates the direction from which the pen receives a light signal. Input signal data may be received as patterns of light levels embedded in an image on a screen via a projector. The light signal may enter the optical pen device 200 through a lens 208 which may focus the light signal onto a photodetector 300 located within the optical pen device. The photodetector 300 can output optical signal data which is based on the light signal. The optical pen device 100 may wirelessly transmit optical signal data via a transmitter 210 (e.g., a radio frequency transmitter) to a projector 202 (illustrated in FIG. 2A). Through a series of patterns, the projector may then calculate where the pen is pointing in the projected image and transmit this to a computer as coordinates (e.g., mouse cursor coordinates).

As disclosed herein, the device includes a housing 304 having a proximal end 306 that is shaped and sized to be placed against a user's palm. At least one switch 312 may be located on the optical input pen device such that the actuation force on an actuation axis 308 is substantially parallel to optical axis 206. The housing 304 is further shaped and proportioned such that the switch 312 is placed about a user's forefinger when the proximal end 306 is against the user's palm. Actuation of the switch can send an actuation signal to a computer, which the computer interprets as a user command with respect to the location of where the pen is pointing (e.g., a mouse click).

In some embodiments, the switch 312 may be off axis such that it is not perpendicular to the optical axis. In some embodiments, the distance between the actuation axis 308 and the optical axis 206 is minimal, to minimize torque applied onto the optical axis 206 via actuation of the switch 312. In some embodiments, the actuation axis 308 and the optical axis 206 are one and the same. With switch actuation/activation, where it is substantially parallel or less than 90 degrees from the optical axis, minimal motion to the pen during the activation process is possible. Minimal motion of the pen prevents the pen from slipping to a new location on the screen or display such that a user can control selection and activation of a desired screen object.

In the example shown in FIG. 3A, the switch 312 includes a key cap 310. The switch 312 may be mounted to a printed circuit board (not shown). Though FIG. 3A shows a particular switch type, it should be understood that any form of switch with the property that the actuation force is parallel, or substantially parallel, to optical axis 206 may be used, such as a membrane switch, a carbon pill in a rubber key cap that makes contact with traces on a printed circuit board, a capacitive style switch, etc. By placing the switch in a location on the bottom of the pen with actuation parallel to the optical axis 206 (e.g., trigger style), the user may comfortably press the switch without substantially changing or altering the angle of the pen. By minimizing change in the position and angle of the pen, change in the location of the pen is minimized. Such a trigger-style switch 312 minimizes movement of the optical pen device when actuated, and thus improves ease of use when a user clicks on window objects via switch 306 in a Windows® environment on a computer, for example.

FIG. 3B illustrates that the switch device 312 is positioned on the optical pen device 200 such that the actuation axis 308, and thus the direction of force applied by a user's forefinger to switch 312, is parallel to optical axis 206 resulting in no to minimal movement of the optical pen (e.g., no angle change 40), as compared with a switch of the prior art optical pen device 10 which requires a perpendicular force to the optical axis. By not affecting the angle of the optical pen device 200 during switch actuation, the user can better control the input and the location where the pen is pointing on the screen or display. As such, in a Windows® environment or other graphic user interface environment, the position of the trigger enables a user to be able to rely on the position of the pen to initiate or actuate a desired function based on location, such as clicking or double-clicking on a Windows® object.

As shown in FIG. 3B, the housing is shaped to be held in the hand of a user such that the forefinger F of the user actuates the switch 212 while a proximal portion of the housing is positioned at and against the adjacent palm P of the user. The forefinger F moves the optical pen device 200 in a direction towards the base of the palm P. Accordingly, the force 308 applied by the forefinger F will push the proximal end of the pen housing into the palm P, as there is a minimal distance between the optical axis 206 and the actuation axis 308, and thus minimal torque is applied onto the optical axis via the force of actuation. The index finger F also does not act as a leverage point as with the prior art pen 10. This results with the optical pen device 200 only moving axially, if at all, with respect to the optical axis 206, and thus does not cause the angle change 40 associated with the prior art optical pen device 10. It is noted that the trigger-style switch may further be more comfortable and easier to manipulate when it is positioned as shown in FIG. 3B.

FIG. 3C shows an optical pen device 320 according to an alternative embodiment of the invention. The optical pen device 320 shares the same general construction with the optical pen device 200. However, the housing 322 of the optical pen device 320 includes an opening 325 which passes through the housing 322. The trigger 312 is located within the opening 325 and is accessible by a user's finger. The actuation axis 326 of the trigger 312 is substantially aligned with the optical axis 206. In some embodiments, the actuation axis 326 and the optical axis 206 are the same axis. An actuation force applied on the actuation axis 326 will cause no to minimal movement of the optical axis 206, as no torque is applied to the optical axis 206 via the actuation force.

FIG. 3D shows an optical pen 340 according to an alternative embodiment of the invention. The optical pen device 340 shares the same general construction with the optical pen device 200. However, the housing 342 of the optical pen 340 includes a trigger 350 which actuates in a liner path that is arranged on the optical axis 206. The trigger 350 is connected to a ring 360 which slides along the optical axis 206 within the housing 342, and is circumferentially placed around the optical axis 206 so as not to block incoming light signals. Accordingly, the trigger 350 and ring 360 slide together along a cylindrically shaped path about the optical axis. An actuation force applied to the trigger 350 on the actuation axis 308 will cause no to minimal movement of the optical axis 206, as no torque is applied to the optical axis 206 via the actuation force.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense since numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

What is claimed is:

1. An optical pen device comprising:
a pen housing being functionally operable and elongated along an optical axis;
an optical sensor within the housing, the optical sensor being arranged to receive a light signal transmitted along the optical axis of the housing;
a transmitter within the housing, the transmitter being configured to wirelessly transmit optical signal data derived from the light signal to an external device; and
an activation switch located on the housing and configured to trigger an activation signal from the transmitter to the external device while the optical data signal is being transmitted,
wherein the activation switch is externally triggered by a force along an actuation axis, the actuation axis being substantially parallel to the optical axis.

2. The optical pen device of claim 1, wherein the optical sensor comprises a photodetector.

3. The optical pen device of claim 2, further comprising:
a lens arranged to focus the light signal onto the photodetector.

4. The optical pen device of claim 1, wherein the transmitter comprises a radio frequency transmitter.

5. The optical pen device of claim 1, wherein the transmitter is mounted to a printed circuit board within the housing.

6. The optical pen device of claim 1, wherein the switch comprises a membrane switch, a carbon pill, or a capacitive switch.

7. The optical pen device of claim 1, wherein the housing is shaped to be held in the hand of a user such that a forefinger of the user actuates the switch while a proximal portion of the housing is positioned against an adjacent palm of the user.

8. The optical pen of claim 1, wherein the actuation axis is positioned at a minimal distance from the optical axis.

9. The optical pen of claim 1, wherein the actuation axis is co-linear with the optical axis.

10. The optical pen device of claim 9, wherein the activation switch is accessible within an opening passing through the housing.

11. The optical pen device of claim 9, wherein the activation switch includes a sliding member that actuates along a cylindrical path about the optical axis.

12. A display system comprising:
an image display device comprising:
an image generation device for projecting an image;
a processor configured to receive optical signal data from an input device and calculate location data for indicating where the input device is pointing on the image,
wherein a computing system is configured to receive the location data from the image display device and send image data to the image display device, the image data being based on the location data;
an optical pen device comprising:
a pen housing being functionally operable and elongated along an optical axis;
an optical sensor within the housing, the optical sensor being arranged to receive a light signal transmitted along the optical axis of the housing, the light signal being received from the image that is projected by the image generation device;
a transmitter within the housing, the transmitter being configured to wirelessly transmit optical signal data derived from the light signal to the image display device; and
an activation switch located on the housing and configured to trigger an activation signal from the transmitter to the image display device while the optical data signal is being transmitted,
wherein the activation switch is externally triggered by a force along an actuation axis, the actuation axis being substantially parallel to the optical axis.

13. The display system of claim 12, wherein the image display device is a front-projection device, a rear-projection device, an LCD system, a laser system, or a large format display device.

14. The display system of claim 12, wherein the location data comprises mouse coordinates.

15. The display system of claim 12, wherein the switch comprises a membrane switch, a carbon pill, or a capacitive switch.

16. The display system of claim 12, wherein the housing is shaped to be held in the hand of a user such that a forefinger of the user actuates the switch while a proximal portion of the housing is positioned against an adjacent palm of the user.

17. The display system of claim 12, wherein the actuation axis is positioned at a minimal distance from the optical axis.

18. The display system of claim 12, wherein the actuation axis is co-linear with the optical axis.

19. The display system of claim 12, wherein the activation switch is accessible within an opening passing through the housing.

20. The display system of claim 12, wherein the activation switch includes a sliding member that actuates along a cylindrical path about the optical axis.
